(19) United States
(12) Patent Application Publication
(10) Pub. No.: US 2026/0211785 A1
(43) Pub. Date: Jul. 23, 2026

(54) FUNCTIONAL TESTING METHOD, DEVICE, AND STORAGE MEDIUM FOR RANDOM ACCESS MEMORY

(71) Applicant: Shenzhen Rayson Technology Co., Ltd., Shenzhen (CN)

(72) Inventor: Zufang Yang, Shenzhen (CN)

(21) Appl. No.: 19/403,891

(22) Filed: Nov. 30, 2025

(30) Foreign Application Priority Data
Jan. 22, 2025 (CN) 2025101026721

(51) Int. Cl. G06F 11/263; G06F 11/22

(52) U.S. Cl. CPC G06F 11/263; G06F 11/2268

(57) ABSTRACT

The disclosure provides a functional testing method, a device, and storage medium for random access memory, belonging to the field of memory technology. The method comprises configuring test function instructions, input parameter items corresponding to the test function instructions, output verification items, and parameter combination patterns corresponding to the input parameter items in a preset test view; determining multiple target input data for the test function instructions based on the input parameter items and the parameter combination patterns; invoking a test template for the test function instructions and generating multiple test cases based on the test template and the multiple target input data; generating a verification script based on the output verification items; issuing test instructions to a target random access memory based on the test cases; querying and outputting test results from the target random access memory based on the verification script.

### TECHNICAL FIELD

This application relates to the field of memory technology, particularly to a functional testing method, device, and storage medium for random access memory.

### BACKGROUND

Random access memory (such as LPDDR5 random access memory) is widely used in mobile phones, tablets, and terminal devices. In practical applications, to ensure the normal performance and functionality of random access memory, functional testing of the random access memory is often required. This functional testing comprises verification of functional instructions corresponding to a single function and stress testing verification through repeated execution of functional instructions. Moreover, for components like random access memory with storage capabilities, it is essential to ensure the normalcy of basic storage states during functional testing. Therefore, multiple types of different data need to be involved in the testing verification process, resulting in a large number of test cases required for testing the functional instructions. Simultaneously, as the storage capacity of random access memory increases, more data needs to be constructed to meet coverage requirements, leading to a corresponding increase in the number and complexity of test cases. Especially when the same function is applied to different memory devices, each test case for the different memory devices needs to be matched one by one, resulting in low testing efficiency.

### SUMMARY

The main objective of the embodiments of this application is to propose a functional testing method, device, and storage medium for random access memory that can enhance testing efficiency.

In order to achieve the aforementioned objective, the first aspect of the embodiments of this application proposes a functional testing method for random access memory, the method comprising:
configuring test function instructions, input parameter items corresponding to the test function instructions, output verification items, and parameter combination patterns corresponding to the input parameter items in a preset test view;
determining multiple target input data for the test function instructions based on the input parameter items and the parameter combination patterns;
invoking a test template for the test function instructions and generating multiple test cases based on the test template and the multiple target input data;
generating a verification script based on the output verification items;
issuing test instructions to a target random access memory based on the test cases;
querying and outputting test results from the target random access memory based on the verification script.

In order to achieve the aforementioned objective, the second aspect of the embodiments of this application proposes an electronic device, the electronic device comprising a memory and a processor, wherein the memory stores a computer program, and the processor implements the functional testing method for random access memory as described in any item of the first aspect when executing the computer program.

In order to achieve the aforementioned objective, the third aspect of the embodiments of this application proposes a computer-readable storage medium, the storage medium storing a computer program that implements the functional testing method for random access memory as described in any item of the first aspect when executed by a processor.

The functional testing method, a device, and storage medium for random access memory proposed in this application realize a basic testing process centered around test function instructions by providing test templates. By configuring input parameter items and output verification items corresponding to test function instructions through a test view, users can focus solely on factors influencing test cases without needing to concern themselves with specific test cases, thereby making the construction of test cases more efficient. Moreover, input data for different testing scenarios is automatically combined and constructed based on input parameter items, and verification scripts for different testing scenarios are constructed based on output verification items. This enables the automatic generation of test cases without the need for manual matching of each test case one by one, resulting in higher testing efficiency. Especially when the same function is adapted to different random access memories, since the test template can be universally applied, testers only need to consider differences in input parameter items and output verification items under different application scenarios to achieve full automation of the testing process and meet testing coverage requirements. Therefore, compared to related technologies, the embodiments of this application offer higher testing efficiency.

### BRIEF DESCRIPTION OF THE DRAWINGS

FIG. 1 is a schematic flow diagram of the functional testing method for random access memory provided by this application;

FIG. 2 is a schematic flow diagram of a test template in an embodiment of the functional testing method for random access memory provided by this application;

FIG. 3 is a schematic diagram of the configuration interface for a test view in an embodiment of the functional testing method for random access memory provided by this application;

FIG. 4 is a schematic diagram of the test case execution interface for a test view in an embodiment of the functional testing method for random access memory provided by this application;

FIG. 5 is a schematic structural diagram of the hardware architecture corresponding to the functional testing method for random access memory provided by this application.

### DETAILED DESCRIPTION

In order to make the objectives, technical solutions, and advantages of this application clearer and more understandable, the following provides further detailed explanations in conjunction with the accompanying drawings and embodiments. It should be understood that the specific embodiments described herein are solely for the purpose of explaining this application and are not intended to limit it.

It should be noted that although functional modules are divided in the device schematic diagrams and logical sequences are shown in the flowcharts, in certain cases, the steps illustrated or described may be executed in a sequence different from the module divisions in the device or the sequence in the flowchart. The terms “first,” “second,” etc., used in the specification, claims, and the aforementioned drawings are for distinguishing similar objects and are not necessarily intended to describe a specific sequence or order.

Unless otherwise defined, all technical and scientific terms used herein have the same meanings as commonly understood by technicians in the technical field to which this application belongs. The terms used herein are solely for the purpose of describing the embodiments of this application and are not intended to limit it.

Firstly, several terms involved in this application are explained:
LPDDR5, also known as Low Power Double Data Rate 5, is a low-power double data rate memory standard.

Random access memory (such as LPDDR5 random access memory) is widely used in mobile phones, tablets, and terminal devices. In practical applications, to ensure the normal performance and functionality of random access memory, functional testing of the random access memory is often required. This functional testing comprises verification of functional instructions corresponding to a single function and stress testing verification through repeated execution of functional instructions. Taking sleep function testing as an example, when a new sleep function is added to random access memory, besides verifying whether the random access memory enters sleep mode after issuing a sleep mode instruction, it is also necessary to repeatedly issue enter and exit instructions to determine whether the random access memory can still maintain normal functionality after multiple executions of the sleep mode instruction. Meanwhile, for components like random access memory with storage capabilities, it is essential to ensure the normalcy of basic storage states during functional testing. Therefore, multiple types of different data need to be involved in the testing verification process, resulting in a large number of test cases required for testing the functional instructions. Simultaneously, as the storage capacity of random access memory increases, more data needs to be constructed to meet coverage requirements, leading to a corresponding increase in the number and complexity of test cases. Especially when the same function is applied to different memory devices, each test case for the different memory devices needs to be matched one by one, resulting in low testing efficiency. Based on this, the embodiments of this application propose a functional testing method, device, and storage medium for random access memory that can enhance testing efficiency.

The functional testing method, device, and storage medium for random access memory provided in the embodiments of this application are specifically described through the following embodiments. Firstly, the functional testing method for random access memory in the embodiments of this application is described.

The functional testing method for random access memory in this application can be applied in various general-purpose or specialized computer system environments or configurations. For example: personal computers, server computers, handheld or portable devices, tablet devices, multiprocessor systems, etc. This application can be described in the general context of computer-executable instructions executed by a computer, such as program modules. Generally, program modules comprise routines, programs, objects, components, data structures, etc., that perform specific tasks or implement specific abstract data types. This application can also be practiced in distributed computing environments, where tasks are executed by remote processing devices connected through a communication network. In distributed computing environments, program modules can be located in both local and remote computer storage media, including storage devices.

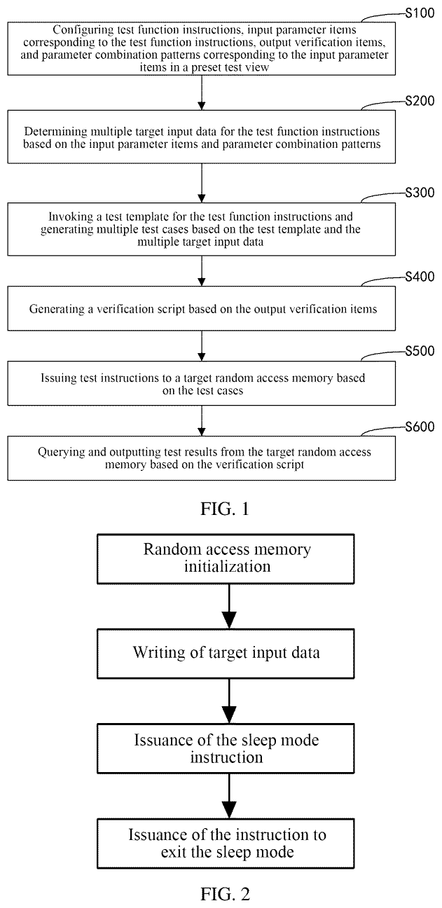

It is understandable that, as shown in FIG. 1, according to a functional testing method for random access memory provided in the embodiments of this application, the method comprises:
Step S100: configuring test function instructions, input parameter items corresponding to the test function instructions, output verification items, and parameter combination patterns corresponding to the input parameter items in a preset test view;
Step S200: determining multiple target input data for the test function instructions based on the input parameter items and parameter combination patterns;
Step S300: invoking a test template for the test function instructions and generating multiple test cases based on the test template and the multiple target input data;
Step S400: generating a verification script based on the output verification items;
Step S500: issuing test instructions to a target random access memory based on the test cases;

Step S600: querying and outputting test results from the target random access memory based on the verification script.

Therefore, by providing a test template to implement a basic testing process centered around test function instructions and configuring input parameter items and output verification items corresponding to the test function instructions through a test view, users can focus solely on factors influencing test cases without needing to concern themselves with specific test cases, thereby making the construction of test cases more efficient. Moreover, input data for different testing scenarios is automatically combined and constructed based on input parameter items, and verification scripts for different testing scenarios are constructed based on output verification items. This enables the automatic generation of test cases without the need for manual matching of each test case one by one, resulting in higher testing efficiency. Especially when the same function is adapted to different random access memories, since the test template can be universally applied, testers only need to consider differences in input parameter items and output verification items under different application scenarios to achieve full automation of the testing process and meet testing coverage requirements. Therefore, compared to related technologies, the embodiments of this application offer higher testing efficiency.

Input parameter items are configured to determine the data to be written into the random access memory for verifying whether the test function instructions are functioning normally. They can be parameters that the test function instructions themselves need to carry; for example, if the test function instruction is a write instruction, the input parameter item is the data to be written in the write instruction. In some other embodiments, input parameter items can also be the data to be written into the random access memory before issuing the test function instructions to ensure that the test function instructions do not affect the data storage functionality of the random access memory. Input parameter items can be matched one by one through an interface view or determined by importing relevant configuration files through a channel. In some embodiments, the functional testing method for random access memory will configure an instruction relationship between the input parameter items and the test function instructions themselves for each test function instruction. Based on this instruction relationship, the method determines whether the target input data should be issued along with the test function instructions themselves or before issuing the test function instructions, thereby matching different strategies for determining target input data.

Output verification items are configured to determine whether the test cases are executed normally. They can comprise the detection of the issuance status of the test function instructions, the detection of storage states to verify the impact of the test function instructions on the storage states, and the detection of the performance of the random access memory to verify the impact of the test function instructions on the performance of the random access memory. This application does not impose restrictions in this regard, and technicians in the field can selectively set them according to actual needs.

The parameter combination pattern is used to determine the combination method of data types for the target input data required by each test case and the proportion of data corresponding to the combined data types. By adding a parameter combination pattern, automatic combination of different data types in the input parameter items can achieved, generating the expected number of test cases while meeting testing coverage requirements. This simplifies the manual construction of data at the testing end and improves testing efficiency.

In some embodiments, the testing platform applying the functional testing method for random access memory can establish connection relationships with various detection devices and provide external query interfaces to query the results of the detection devices. This allows corresponding verification items to be added to the output verification items, thereby meeting verification needs in different scenarios.

The verification script and the test case are two independent entities. The test case and the verification script are executed synchronously on a one-to-one basis, meaning that when each test case is executed, the corresponding verification script for the same function instruction is simultaneously invoked. By using the verification script to monitor the status of the corresponding test case in real-time, the verification of the test results for the function instructions can be achieved. Moreover, by decoupling the verification script and the test case, the generation of test cases is simplified, further reducing the probability of manual intervention in test cases. This enables automatic testing of function instructions in various scenarios while achieving personalized verification requirements.

The test template is used to record the issuance process when verifying the functions of test function instructions. For example, taking the sleep mode instruction as a functional instruction, as shown in FIG. 2, the test template for the sleep mode instruction is as follows: random access memory initialization; writing of target input data; issuance of the sleep mode instruction; issuance of the instruction to exit the sleep mode. In this case, each target input data can be combined with this test template to form test cases under different input scenarios of target input data. Taking a write instruction as an example, the test template can be set as follows: random access memory initialization; issuance of the write instruction, or the test template can be set simply as the issuance of the write instruction.

The embodiments of this application do not impose restrictions on input parameter items, output verification items, or parameter combination patterns. Technicians in the field can selectively set them according to actual needs.

The target random access memory refers to the random access memory to be tested.

It is understandable that the input parameter items comprise data type parameters and data length parameters, while the parameter combination pattern comprises type proportion parameters and the total number of test cases. Determining multiple target input data for the test function instructions based on the input parameter items and parameter combination pattern, comprises at least one of the following:
generating multiple input data based on the data length parameters and data type parameters, where the data type parameters and/or data length parameters of each input data are different;
determining multiple data type combinations and the corresponding number of test cases for each combination based on the type proportion parameters and the total number of test cases.
each data type combination is composed of at least one data type parameter;
randomly selecting one input data multiple times from the multiple input data corresponding to each data type parameter based on the number of test cases for each data type combination;
combining the randomly selected target input data for each data type combination in each instance to obtain the total number of target input data corresponding to the total number of test cases.

Random selection can be performed in the following manner: sorting each input data of the same data type and assigning data numbers based on the sorting order, and then randomly selecting data based on the data numbers, such as using the rand( ) function to determine the selected data number. This allows for random selection of each input data. Although the length of each input data is fixed, since the input data forming the target input data is randomly selected, the target input data is also random and varies in length, thereby further ensuring testing coverage and accuracy.

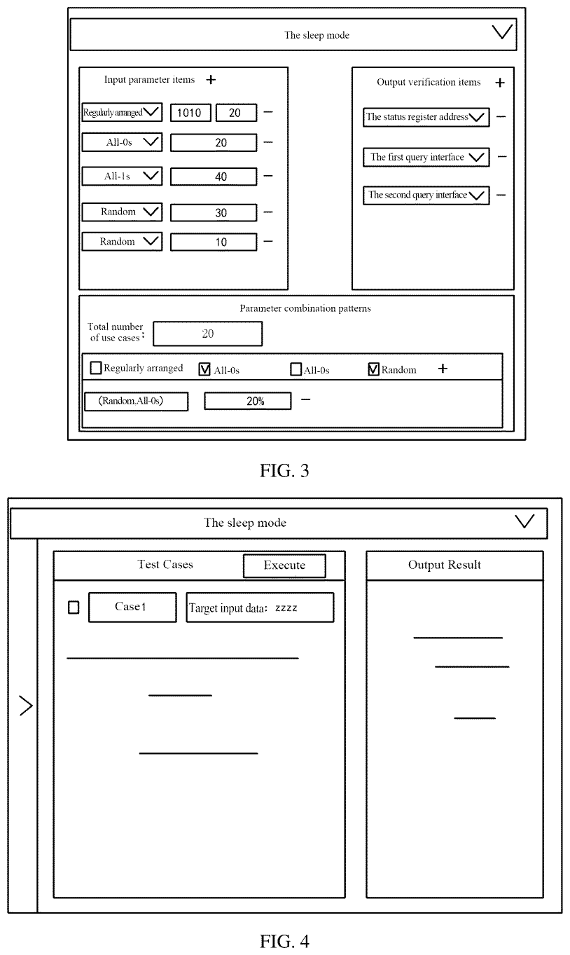

The type proportion parameters define the proportions of different data type combinations. For example, as shown in FIG. 3, by checking the data types to be combined and adding corresponding data type combination items using “+” input control, the type proportion parameters can be obtained by entering the input proportions in the displayed data type combination items. As shown in FIG. 3, after checking “All 0s” and “Random”, selecting the “+” control displays an input item in the display area corresponding to the parameter combination pattern. The input item comprises the generated data type combination and a proportion input text box. Entering the corresponding proportion in the proportion input text box yields a type proportion parameter. Technicians in the field can selectively set the specific content and quantity of the type proportion parameters according to actual needs. This application does not impose restrictions on this aspect, nor on how to obtain the type proportion parameters. Technicians can refer to the method shown in FIG. 3 or use other methods. In some embodiments, a delete control “−” is provided for each input item, enabling manual deletion of type proportion parameters.

The total number of test cases refers to the desired total number of test cases to be generated.

For example, suppose there are three data types set: Type 1, Type 2, and Type 3. The type proportion parameters specify that the proportion of test cases combining Type 1 and Type 2 is 10%, the proportion of test cases combining Type 2 and Type 3 is 20%, the proportion of test cases for Type 2 alone is 30%, the proportion of test cases combining Type 1, Type 2, and Type 3 is 20%, and the proportion of test cases for Type 1 alone is 20%. Based on these type proportion parameters, the number of test cases for each different data type combination can be determined. For example, as shown in FIG. 3, if the total number of test cases is 20, the number of test cases for the data type combination of (Random, All 0s) is 20*20% =4. This means that among the four target input data to be generated, each target input data consists of one input data of a random type and one input data of an all-0s type.

It is understandable that the test function instruction is the sleep mode instruction, and the data type parameters comprise the regularly arranged type, random type, all-1s type, and all-0s type.

The regularly arranged type represents data arranged in a certain pattern, such as 10101010 or 110110110, where some data repeats.

By setting the regularly arranged type, random type, all-1s type, and all-0s type and combining them based on these four types, a wider coverage of target input data can be achieved.

For example, referring to the test view shown in FIG. 3, display areas corresponding to input parameter items, output verification items, and parameter combination patterns are defined in the test view. In the display area for input parameter items, data type items can be added using the “+” button. As shown in FIG. 3, each data type item comprises a type drop-down box and a data length text box. The type drop-down box comprises the regularly arranged type, random type, all-1s type, and all-0s type. The regularly arranged type represents periodic changes in the fixed content of bit data, the random type represents randomly generated data where there is no correlation between any bits, the all-1s type represents that each bit of data is 1, and the all-0s type represents that each bit of data is 0. For example, as shown in FIG. 3, in the first data type item, the type drop-down box selects “Regular Distribution”, generating a fixed content input box and a data length text box for the regularly distributed type. When the content of the fixed content input box is 1010 and the content of the corresponding data length text box is 20, the corresponding input data obtained is 10101010101010101010. Similarly, multiple data type items can be generated using the above method. In some embodiments, a delete control “−” is provided on the right side of each data type item, enabling deletion of the data type item using this control.

It is understandable that the output verification items comprise an external query interface and a status register address. Generating a verification script based on the output verification items comprises:
generating a monitoring instruction to periodically monitor the issuance status of test cases, so as to determine the execution status of the test cases and the issuance status of the test function instructions in the test cases based on the monitoring instruction;
determining a first query instruction based on the status register address;
determining a second query instruction based on the external query interface;
obtaining the target input data of the currently executed test case and generating a third query instruction based on the target input data;
configuring the trigger condition for the first query instruction as the issuance status of the test function instructions in the test case being completed, resulting in the first script instruction;.
configuring the trigger condition for the second query instruction as the query result of the first query instruction matching the expected memory value or the execution status of the test case being completed, resulting in the second script instruction;
configuring the trigger condition for the third query instruction as the execution status of the test case being completed, resulting in the third script instruction;
generating a fourth script instruction based on the query result of the third query instruction and the corresponding target input data;
generating a verification script based on the first script instruction, second script instruction, third script instruction, and fourth script instruction;.

By periodically monitoring the issuance status of corresponding test cases, synchronous execution of the verification script and test cases can be achieved.

The status register address is the address of the memory in the random access memory that records the corresponding functional test status.

By setting the query of the target written data as the default verification item and providing two methods, namely the external query interface and the status register address, the number of configuration items for the verification content that users need to set can be reduced. Meanwhile, an appropriate verification method can be selected according to the actual test environment, thus meeting the needs of different test scenarios.

It is understandable that the items in the output verification items can be selectively set according to actual needs. For example, as shown in FIG. 3, verification items can be added in the input area of the output verification items. For instance, by clicking the “+” button, a verification item drop-down box is generated, and the corresponding verification item can be selected from the options in the drop-down box, resulting in different output verification items for different functional instructions. As shown in FIG. 3, three verification items have been added, with the verification item drop-down boxes of the three verification items set to the status register address, the first query interface, and the second query interface from top to bottom, respectively.

It is understandable that the external query interface comprises a first query interface for querying the detection results of a power detection device and a second query interface for querying the detection results of a current detection device.

By providing interface queries for external detection devices such as power and current detectors, simultaneous verification of multiple dimensions, including the self-status and performance of the random access memory, can be performed to check for abnormalities. Especially for functional tests related to performance, such as functional tests in sleep mode, the accuracy of the verification results can be further ensured.

It is understandable that querying the test results from the target random access memory and outputting them based on the verification script comprises:
invoking the first query instruction using the first script instruction to obtain the memory value in the preset memory address of the memory after executing the test function instructions;
invoking the first query interface using the second script instruction to obtain the power test value and invoking the second query interface using the second script instruction to obtain the current value, when the memory value matches the expected memory value;
outputting a test failure and displaying the reason for the failure when the power test value is greater than the preset power threshold or the current value is greater than the preset current threshold;
invoking the third query instruction using the third script instruction to obtain the actual register written value;
comparing the actual register written value with the corresponding target input data using the fourth script instruction and outputting the comparison result.

Exemplarily, referring to FIG. 4, after the test cases are generated, one can enter the test view as shown in FIG. 4. The test view displays a test case area and an output result area. In the test case area, the numbers of each test case and the corresponding target input data are displayed. When the corresponding test case is checked and “Execute” is selected, data such as the failure reasons and comparison results for each test case will be displayed in the output result area. In some embodiments, as shown in FIG. 4, view interfaces such as input parameter items and output verification items are collapsed on the left side in the form of tabs. They can be expanded by clicking and then reset to generate new test cases.

It can be understood that before sending test instructions to the target random access memory (RAM) based on the test cases, the method also comprises:
obtaining environmental parameters from the test view;
generating multiple case initialization scripts based on the environmental parameters;
binding the multiple case initialization scripts to each test case;
sending test instructions to the target RAM correspondingly based on the test cases comprises:
   executing the case initialization scripts;
   sending test instructions to the target RAM based on the test cases corresponding to the case initialization scripts.

By adding the configuration of environmental parameters, it is possible to comprehensively consider test verification in actual usage scenarios, further ensuring the accuracy of the verification results. Moreover, by visualizing environmental parameters as independent case initialization scripts, it is possible to adapt to more different functional instructions while supporting the saving of these environmental parameters, thereby improving test efficiency.

It can be understood that the above-mentioned input parameter items and parameter combination modes can generate an independent first configuration file for output. When configuring test function instructions subsequently, this first configuration file can be directly imported. Similarly, the output verification items can also be output as a separate second configuration file. When configuring test function instructions, this second configuration file can be directly imported, eliminating the need for manual configuration. At this point, by generating a test template, the first configuration file, the second configuration file, and case initialization scripts separately, the generation of test cases can achieve modular combination, enabling adaptation to RAM testing in more scenarios and improving test efficiency.

It can be understood that the method also comprises:
obtaining the number of tests from the test view;
jumping to execute the case initialization script when the number of executions of the currently executed test case is less than the number of tests;
   selecting an unexecuted test case from multiple test cases for execution until each test case has completed the specified number of tests when the number of executions of the currently executed test case is equal to the number of tests.

By setting the number of tests, stress testing of the RAM can be achieved, further ensuring the accuracy of the tests. The visualized configuration of the number of tests can improve the configuration efficiency of testers and provide greater flexibility.

The embodiments of this application also provide an electronic device. The electronic device comprises a memory and a processor. The memory stores a computer program. When the processor executes the computer program, the above-mentioned functional testing method for a random access memory (RAM) is implemented. This electronic device can be any intelligent terminal, including but not limited to tablet computers and in-vehicle computers.

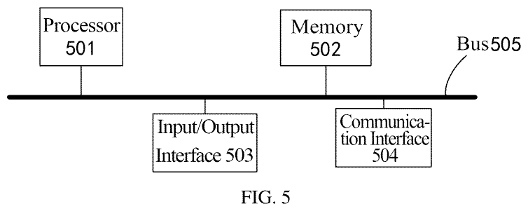

Please refer to FIG. 5, which illustrates the hardware structure of an electronic device in another embodiment. The electronic device comprises:
a processor 501, which can be implemented using a general-purpose CPU (Central Processing Unit), a microprocessor, an Application-Specific Integrated Circuit (ASIC), or one or more integrated circuits; wherein the processor 501 is used to execute relevant programs to implement the technical solutions provided in the embodiments of this application;
a memory 502, which can be a NAND flash. Relevant program codes are stored in the memory 502, and the processor 501 calls and executes these codes to implement the functional testing method for a RAM as described in the embodiments of this application;
an input/output interface 503, which is used to achieve information input and output;
a communication interface 504, which is used to enable communication and interaction between this device and other devices; wherein communication can be achieved through wired means (such as USB, network cables, etc.) or wireless means (such as mobile networks, Wi-Fi, Bluetooth, etc.);
a bus 505, which transmits information among various components of the device (such as the processor 501, memory 502, input/output interface 503, and communication interface 504).

Here, the processor 501, memory 502, input/output interface 503, and communication interface 504 are interconnected within the device through the bus 505 to enable communication.

The embodiments of this application also provide a computer-readable storage medium. This computer-readable storage medium stores a computer program that, when executed by a processor, implements the above-mentioned functional testing method for a random access memory (RAM).

As a non-transitory computer-readable storage medium, the memory can be used to store non-transitory software programs and non-transitory computer-executable programs. Additionally, the memory may comprise high-speed random-access memory and non-transitory memory, such as at least one magnetic disk storage device, flash memory device, or other non-transitory solid-state storage devices. In some embodiments, the memory may optionally comprise memory located remotely from the processor, and these remote memories can be connected to the processor over a network. Examples of such networks comprise, but are not limited to, the Internet, intranets, local area networks, mobile communication networks, and combinations thereof.

The embodiments described in this application are intended to provide a clearer illustration of the technical solutions presented herein and do not constitute limitations on these solutions. Skilled individuals in the field should understand that as technology evolves and new application scenarios emerge, the technical solutions provided in this application are equally applicable to similar technical problems.

It should be understood by skilled individuals in the field that the technical solutions depicted in the figures do not constitute limitations on the embodiments of this application. They may comprise more or fewer steps than illustrated, or combine certain steps, or employ different steps.

The device embodiments described above are merely illustrative. The units described as separate components may or may not be physically separated, meaning they can be located in the same place or distributed across multiple network units. Depending on actual needs, some or all of the modules can be selected to achieve the objectives of the embodiments of this application.

Ordinary skilled persons in the art can understand that all or some of the steps, functional modules/units in the methods, systems, and devices disclosed above can be implemented as software, firmware, hardware, or a combination thereof.

The terms “first,” “second,” “third,” “fourth,” etc. (if present) in the description and accompanying figures of this application are configured to distinguish similar objects and do not necessarily denote a specific order or sequence. It should be understood that the data used in this manner can be interchanged as appropriate, so that the embodiments of this application described herein can be implemented in sequences other than those illustrated or described. Furthermore, the terms “comprise” and “have,” as well as any variations thereof, are intended to cover non-exclusive inclusions. For example, a process, method, system, product, or device that comprises a series of steps or units is not necessarily limited to those steps or units clearly listed but may comprise other steps or units not clearly listed or inherent to such processes, methods, products, or devices.

It should be understood that in this application, “at least one (item)” refers to one or more, and “multiple” refers to two or more. The term “and/or” is used to describe the associative relationship between associated objects, indicating that three relationships may exist. For example, “A and/or B” may represent: only A exists, only B exists, and both A and B exist simultaneously. Here, A and B can be singular or plural. The character “/” generally indicates that the associated objects before and after it have an “or” relationship. “At least one (item) of the following” or similar expressions refer to any combination of these items, including single items or multiple items in any combination. For example, “at least one (item) of a, b, or c” may represent: a, b, c, “a and b,” “a and c,” “b and c,” or “a, b, and c.” Here, a, b, and c can be singular or plural.

In the several embodiments provided by this application, it should be understood that the disclosed devices and methods can be implemented in other ways. For example, the device embodiments described above are merely illustrative. The division of the aforementioned units is merely a logical functional division, and in actual implementation, there may be other division methods. For example, multiple units or components may be combined or integrated into another system, or some features may be ignored or not executed. Additionally, the coupling or direct coupling or communication connection between the displayed or discussed components may be indirect coupling or communication connection through some interfaces, devices, or units, which may be electrical, mechanical, or other forms.

The units described as separate components may or may not be physically separated, and the components displayed as units may or may not be physical units. They can be located in the same place or distributed across multiple network units. Depending on actual needs, some or all of the units can be selected to achieve the objectives of the embodiments of this application.

Furthermore, the functional units in the various embodiments of this application can be integrated into one processing unit or can exist separately as individual physical units. Alternatively, two or more units can be integrated into one unit. These integrated units can be implemented in hardware or as software functional units.

If the integrated units are implemented as software functional units and sold or used as independent products, they can be stored in a computer-readable storage medium. Based on this understanding, the technical solutions of this application, either in whole or in part, or the contributions made to existing technology, can be embodied in the form of software products. These computer software products are stored in a storage medium and comprise multiple instructions to enable a computer device (which can be a personal computer, server, or network device, etc.) to execute all or part of the steps of the methods described in the various embodiments of this application. The aforementioned storage medium comprises various media capable of storing programs, such as USB drives, mobile hard drives, read-only memory (ROM), random-access memory (RAM), magnetic disks, or optical disks.

The preferred embodiments of this application have been described above with reference to the accompanying figures, but this does not limit the scope of rights of this application. Any modifications, equivalent substitutions, or improvements made by skilled individuals in the field without departing from the scope and essence of this application should fall within the scope of rights of this application.

1. A functional testing method for random access memory, the comprising:
configuring test function instructions, input parameter items corresponding to the test function instructions, output verification items, and parameter combination patterns corresponding to the input parameter items in a preset test view;
determining multiple target input data for the test function instructions based on the input parameter items and the parameter combination patterns;
invoking a test template for the test function instructions and generating multiple test cases based on the test template and the multiple target input data;
generating a verification script based on the output verification items;
issuing test instructions to a target random access memory based on the test cases;
querying and outputting test results from the target random access memory based on the verification script;
wherein the output verification items comprise an external query interface and a status register address; the generating the verification script based on the output verification items comprises:
generating a monitoring instruction to periodically monitor the issuance status of the test cases to determine the execution status of the test cases and the issuance status of the test function instructions in the test cases based on the monitoring instruction;
determining a first query instruction based on the status register address;
determining a second query instruction based on the external query interface;
obtaining the target input data of the currently executed test case and generating a third query instruction based on the target input data;
setting trigger condition of the first query instruction to be when the issuance status of the test function instructions in the test cases is completed, to obtain a first script instruction;
setting trigger condition of the second query instruction to be when the query result of the first query instruction matches the expected memory value or the execution status of the test cases is completed, to obtain a second script instruction;
setting trigger condition of the third query instruction to be when the execution status of the test cases is completed, to obtain a third script instruction;
generating a fourth script instruction based on the query result of the third query instruction and the corresponding target input data;
generating the verification script based on the first script instruction, the second script instruction, the third script instruction, and the fourth script instruction.

2. The functional testing method for random access memory according to claim 1, wherein the input parameter items comprise data type parameters and data length parameters, and the parameter combination patterns comprise type proportion parameters and total case numbers; the determining multiple target input data for the test function instructions based on the input parameter items and the parameter combination patterns, comprises:
generating multiple input data based on the data length parameters and the data type parameters, wherein the data type parameters and/or data length parameters of each input data are different;
determining multiple data type combinations and the case numbers corresponding to each data type combination based on the type proportion parameters and the total case numbers, wherein each data type combination consists of at least one data type parameter;
randomly selecting one input data multiple times from the multiple input data corresponding to each data type parameter based on the case numbers for each data type combination;
combining each randomly selected target input data for each data type combination to obtain the total number of target input data equal to the total case numbers.

3. The functional testing method for random access memory according to claim 2, wherein the test function instruction is a sleep mode instruction; the data type parameters comprise regular arrangement type, random type, all-1 type, and all-0 type.

4. The functional testing method for random access memory according to claim 1, wherein the external query interface comprises a first query interface for querying the detection results of a power detection device and a second query interface for querying the detection results of a current detection device.

5. The functional testing method for random access memory according to claim 4, wherein the querying and outputting test results from the target random access memory based on the verification script, comprises:
invoking the first query instruction through the first script instruction to obtain a memory value in the preset memory address of the memory after executing the test function instructions;
invoking the first query interface through the second script instruction to obtain a power test value and invoking the second query interface through the second script instruction to obtain a current value when the memory value matches the expected memory value;
outputting a test failure and displaying the reason for the failure when the power test value is greater than a preset power threshold or the current value is greater than a preset current threshold;
invoking the third query instruction through the third script instruction to obtain a actual register write value;
comparing the actual register write value with the corresponding target input data through the fourth script instruction and outputting a comparison result.

6. The functional testing method for random access memory according to claim 1, wherein before issuing test instructions to the target random access memory based on the test cases, the method further comprises:
obtaining environmental parameters from the test view;
generating multiple case initialization scripts based on the environmental parameters;
binding multiple case initialization scripts with each the test case;
correspondingly, the issuing test instructions to the target random access memory based on the test cases comprises:
executing the case initialization scripts;
issuing test instructions to the target random access memory based on the test cases corresponding to the case initialization scripts.

7. The functional testing method for random access memory according to claim 6, wherein the method further comprises:
obtaining a number of tests from the test view;
when execution count of the currently executed test case is less than the number of tests, jumping to the executing the case initialization scripts;
selecting an unexecuted test case from the multiple test cases for execution until each test case has completed the number of tests when the execution count of the currently executed test case is equal to the number of tests.

8. An electronic device, wherein the electronic device comprises a memory and a processor, the memory stores a computer program, and the processor, when executing the computer program, implements the functional testing method for random access memory according to claim 1.

9. A computer-readable storage medium, the storage medium stores a computer program, wherein the computer program, when executed by a processor, implements the functional testing method for random access memory according to claim 1.
